(19) United States
(12) Patent Application Publication
(10) Pub. No.: US 2022/0067153 A1
(43) Pub. Date: Mar. 3, 2022

(54) Artificial Intelligence Embedded and Secured Augmented Reality

(71) Applicant: The Government of the United States, as represented by the Secretary of the Army, Washington, DC (US)

(72) Inventor: Radhika Roy, Howell, NJ (US)

(21) Appl. No.: 17/011,243

(22) Filed: Sep. 3, 2020

(51) Int. Cl. G06F 21/55; G06T 19/00; G06N 20/00

(52) U.S. Cl. CPC G06F 21/554; G06N 20/00; G06T 19/006

(57) ABSTRACT

Various embodiments that pertain to augmented reality security. A user interface can disclose an augmented reality. The user interface and/or augmented reality can be subjected to security protections. In one example, a check can be made on if an unknown party is viewing the augmented reality. If this occurs, then a notification can be emitted announcing a potential security breach.

### GOVERNMENT INTEREST

The innovation described herein may be manufactured, used, imported, sold, and licensed by or for the Government of the United States of America without the payment of any royalty thereon or therefor.

### BACKGROUND

A communications network can include multiple devices that communicate with one another. These devices can produce their own information sets that can be valuable in a wide variety of circumstance. However, while more information can be valuable, more information can also be detrimental. For example, in a network with a great multitude of devices, so much information can be produced that valuable information is hard to find and buried in relatively irrelevant information. If the entirety of the information for the network is provided to a user, then the user can suffer from information overload. With information overload, the user can make an incorrect decision because the user did not appreciate the vital information or the user can fail to act in a timely manner due to being overwhelmed with information.

### SUMMARY

In one embodiment, an artificial intelligence-based augmented reality system comprises an interface component and a security component. The interface component can be configured to cause display of a user interface. The security component can be embedded in an artificial intelligence platform and can be configured to limit access to the user interface. The user interface can display an augmented reality that combines real-world imagery with augmented imagery. The augmented reality can be produced through employment of the artificial intelligence platform.

In another embodiment, a system comprises a production component configured to produce an augmented reality through employment of an artificial intelligence platform. The system can also comprise a security component, embedded in the artificial intelligence platform, configured to limit access to the production component to an allowable party set. The augmented reality can be accessible by way of a user interface.

In yet another embodiment, an artificial intelligence-based augmented reality system, which is at least partially hardware, comprises an interface component, a security component and a notification component. The security component can be embedded in an artificial intelligence platform and can be configured to identify a security breach to an augmented reality presented on a user interface. The notification component can be configured to provide a real-time notification to the user about the security breach by way of the user interface

### BRIEF DESCRIPTION OF THE DRAWINGS

Incorporated herein are drawings that constitute a part of the specification and illustrate embodiments of the detailed description. The detailed description will now be described further with reference to the accompanying drawings as follows:

FIG. 1A illustrates one embodiment of a system comprising an interface component and a security component;

FIG. 1B illustrates one embodiment of a user interface;

FIG. 2 illustrates one embodiment of a system comprising a production component and the security component;

FIG. 3 illustrates one embodiment of a system comprising the production component, the interface component, the security component, an analysis component, a determination component, and a notification component;

FIG. 4 illustrates one embodiment of a system comprising the production component, the interface component, the security component, the analysis component, the determination component, the notification component, a task component, a collection component, an identification component, an update component, an investigation component, and a correlation component;

FIG. 5 illustrates one embodiment of a system comprising a processor and a computer-readable medium;

FIG. 6 illustrates one embodiment of a method comprising two actions;

FIG. 7 illustrates one embodiment of a method comprising two actions;

FIG. 8 illustrates one embodiment of a method comprising four actions;

FIG. 9 illustrates one embodiment of a method comprising seven actions;

FIG. 10A illustrates one embodiment of a detection platform;

FIG. 10B illustrates one embodiment of a network architecture; and

FIG. 10C illustrates one embodiment of an applications architecture.

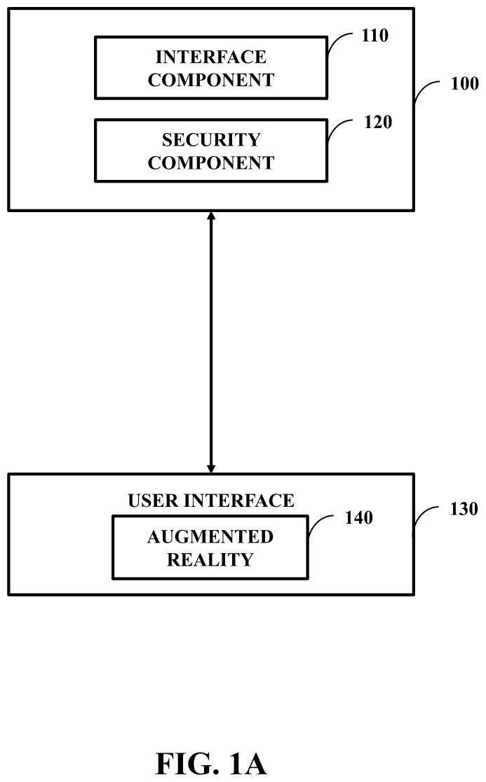

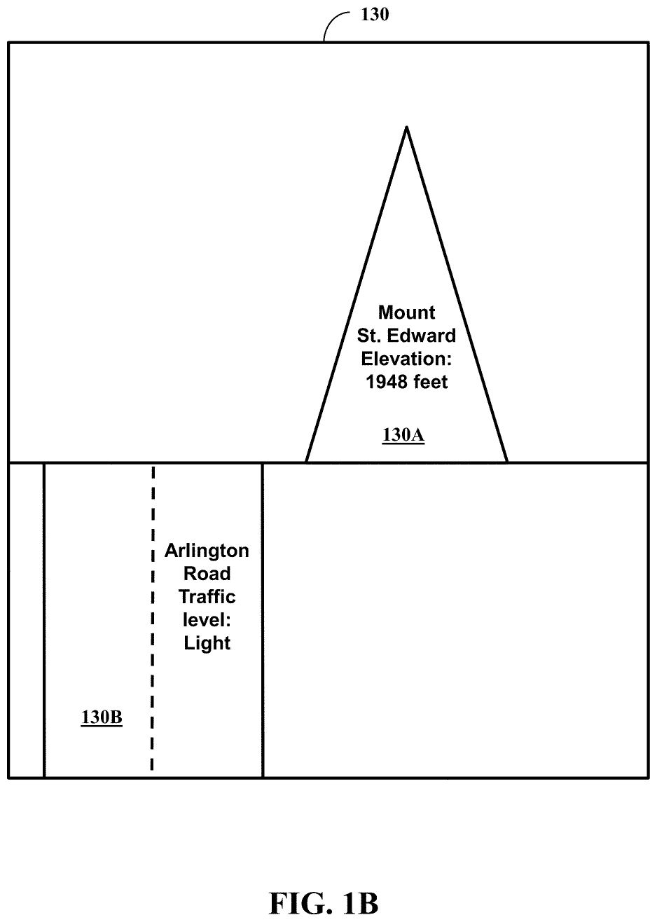

Multiple figures can be collectively referred to as a single figure. For example, FIG. 1 illustrates two subfigures—FIG. 1A and FIG. 1B. These can be collectively referred to as ‘FIG. 1.’

### DETAILED DESCRIPTION

A user can look at a screen or wearable display to see what is actually in front of him or her. What is actually in front of the user can be augmented with metadata to give the user a greater situational awareness. It can be important to keep what the user sees secure, both from a content protection standard and a knowledge-based standard. From the content protection standard, it can be important that no outside party modify the metadata. Meanwhile, from the knowledge-based standard, it can be important that no outside party know what the user is looking or know the metadata.

In one example, the screen can present a computer generated three-dimensional (3D) digital terrain map. The computer generated digital map can be created in a manner in which components of the digital world blend into a person's perception of the real world, not as a simple display of data, but through the integration of immersive sensations, which are perceived as natural parts of an environment. This creation can be creation of augmented reality.

The creation of augmented reality can be highly complex and can include integration of various objects, data, files, and/or applications located at different locations of a communication network. Therefore, artificial intelligence (AI) that employs machine learning and/or deep learning (ML/DL) technologies can be used to proactively create the augmented reality, such as though an augmented reality application (e.g., the 3-D map).

However, the augmented reality can be prone to errors because of cyberattacks and/or noises when the information is transferred over the network. The user can misidentify which hill he or she is looking at on the AI-enabled augmented reality-generated application (e.g., the 3-D map) and therefore proceed with incorrect information. However, AI-enabled secure augmented reality can prevent both cyberattacks and communication noises.

To achieve this, vast amount of inputs from multiple sources can be correlated and potentially lead to information overloads. The AI-enabled AR-generated cybersecurity application can display information in 3D form correlating pieces of information located at different places across the network proactively in real-time without using manual efforts, thereby, reducing information overloads for the user. On the other hand, AI/ML/DL technologies can also be used to prevent cyberattacks in computer communication systems including networks and applications.

Various embodiments can be practiced that pertain to augmented reality security. A user interface can disclose an augmented reality. The user interface and/or augmented reality can be subjected to security protections. In one example, a check can be made on if an unknown party is viewing the augmented reality. If this occurs, then a notification can be emitted announcing a potential security breach. A secure artificial intelligence (AI)-based secured augmented reality (AR)-enhanced platform can be configured (e.g., in each layer of a user's application architecture) to reduce security information overloads for the user. The secured AR interface can function as the final user interface for individual layers of application architecture while AI comprises core common infrastructure including AR and cybersecurity. AI-enabled cybersecurity application of an individual layer can be configured with AI-enabled-AR platform for reducing information overloads. The 3D representations of real-world information augmented with annotated virtual-world objects can be employed for decision making, being a result of correlating a vast amount of inputs from multiple sources to make it easier for warfighters/soldiers/users to make decisions in real-time. The AI-enabled secured AR user interface can foster interoperability and scalability using AR and AI as the common technology for cybersecurity application as well as for all other applications both for military and commercial networks.

The following includes definitions of selected terms employed herein. The definitions include various examples. The examples are not intended to be limiting.

“One embodiment”, “an embodiment”, “one example”, “an example”, and so on, indicate that the embodiment(s) or example(s) can include a particular feature, structure, characteristic, property, or element, but that not every embodiment or example necessarily includes that particular feature, structure, characteristic, property, or element. Furthermore, repeated use of the phrase “in one embodiment” may or may not refer to the same embodiment.

“Computer-readable medium”, as used herein, refers to a medium that stores signals, instructions and/or data. Examples of a computer-readable medium include, but are not limited to, non-volatile media and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, other optical medium, a Random Access Memory (RAM), a Read-Only Memory (ROM), a memory chip or card, a memory stick, and other media from which a computer, a processor or other electronic device can read. In one embodiment, the computer-readable medium is a non-transitory computer-readable medium.

“Component”, as used herein, includes but is not limited to hardware, firmware, software stored on a computer-readable medium or in execution on a machine, and/or combinations of each to perform a function(s) or an action(s), and/or to cause a function or action from another component, method, and/or system. Component may include a software controlled microprocessor, a discrete component, an analog circuit, a digital circuit, a programmed logic device, a memory device containing instructions, and so on. Where multiple components are described, it may be possible to incorporate the multiple components into one physical component or conversely, where a single component is described, it may be possible to distribute that single component between multiple components.

“Software”, as used herein, includes but is not limited to, one or more executable instructions stored on a computer-readable medium that cause a computer, processor, or other electronic device to perform functions, actions and/or behave in a desired manner. The instructions may be embodied in various forms including routines, algorithms, modules, methods, threads, and/or programs, including separate applications or code from dynamically linked libraries.

FIG. 1A illustrates one embodiment of a system 100 comprising an interface component 110 and a security component 120 and FIG. 1B illustrates one embodiment of a user interface 130. The system 100 can be an artificial intelligence-based augmented reality system that works with the user interface 130. The interface component 110 can be configured to cause display of a user interface 130, with the user interface displaying an augmented reality 140 that combines real-world imagery with augmented imagery. The security component 120 (e.g., that is embedded in an artificial intelligence platform) can configured to limit access to the user interface 130.

The user interface 130 can be a screen or eyewear element of a wearable device, such as lens of a pair of goggles. When the user looks at the user interface 130, the user can see a live image. As an example, the live image can include two features—a hill 130A and a road 130B. The live image can be augmented with metadata such that the user interface 130 displays the augmented reality 140. Continuing the example, the hill 130A can be listed with a hill name “Mount St. Edward” and a height with title “Elevation: 1948 feet” while the road 130B can be listed with a road name “Arlington Road” and a condition with title “Traffic level: Light.” The hill name, height with title, road name, and condition with title can be augmented—not actually visible, but added. This can be done in an immersive manner that can be difficult for the user to determine if the text is there in real-life or not.

The security component 120 can limit access to the user interface 130. This limited access can manifest in different manners. One manner is to shield other parties from knowing what is contained in the user interface 130. In one example, there can be a race between multiple competitors. While the user interface 130 illustrates one road, it is possible that the user interface 130 displays multiple roads. However, one road can have augmented data—road 130B—with the others remaining unaugmented. If a fellow competitor saw the interface 130, then he or she may ascertain that the user plans to travel Arlington Road. This could cause the fellow competitor to change his or her strategy and result in an unfair competition. Therefore, the security component 120 can function to limit access of the user interface 130 to other competitors 130 as displayed.

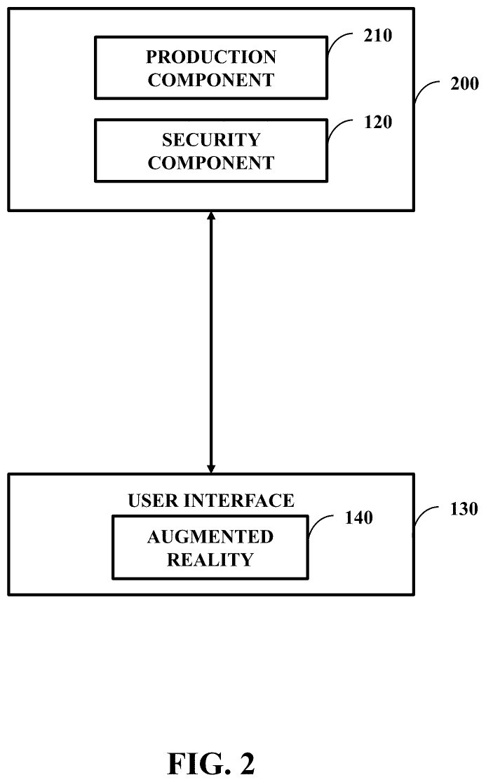

FIG. 2 illustrates one embodiment of a system 200 comprising a production component 210 and the security component 120. The production component 210 can be configured to produce the augmented reality 140 through employment of the artificial intelligence platform. The security component 120, which can be embedded in the artificial intelligence platform, can be configured to limit access to the augmented reality 140 to an allowable party set, such as limiting access to the production component 210 in production of the augmented reality 140 and/or limiting access to the user interface 130. The augmented reality 140 can be accessible to the allowable party set through the user interface 130.

One manner can be to limit access can limit entities that can produce the augmented reality 140. Returning to the race between competitors example, Mount St. Edward may be one of multiple peaks illustrated and be may the shortest. If the race is to reach a point beyond a range of hills Mount St. Edward is part of, then Mount St. Edward may be the most advantageous to traverse due to it having the shortest peak. If a competitor could change the elevation displayed from “1948” to “2048” and thus removing Mount St. Edward from being the shortest, then it could cause a change of route for the user. This change of route could hamper success of the user since the user would be avoiding the actual shortest hill based on misinformation. Therefore, the security component 120 can protect the creation and management of the augmented reality 140 and the user interface 130.

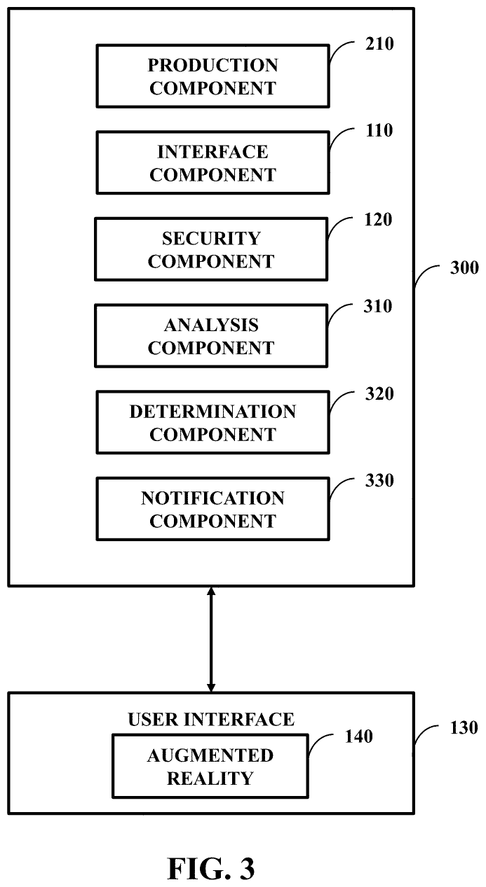

FIG. 3 illustrates one embodiment of a system 300 comprising the production component 210, the interface component 110, the security component 120, an analysis component 310, a determination component 320, and a notification component 330. The production component 210 can be configured to produce the augmented reality 140 through employment of the artificial intelligence platform. The interface component 110 can be configured to cause presentment of the user interface 130 that displays the augmented reality 140 that combines real-world imagery with augmented imagery. The security component 120, embedded in the artificial intelligence platform, can be configured to limit access to the user interface and/or limit access to the production component 210 (e.g., limit access to the logic employed by the production component 220 and/or metadata used by the production component 220 in producing the augmented reality 140).

The analysis component 310 can be configured to analyze the artificial intelligence platform to produce an analysis result. The determination component 320 can be configured to make a determination if the artificial intelligence platform has experienced a security breach based, at least in part, on the analysis result. The notification component 330 can be configured to provide a notification that indicates existence of the security breach when the determination is that the artificial intelligence platform has experienced a breach. The components 310-330 can be employed by the security component 120 to manage security.

The user interface 130 can be employed in different environments and scenarios. In one example, the user interface 130 can be deployed in a natural disaster scenario, such as by a rescue worker in the aftermath of an earthquake. The augmented reality 140 can provide information such as where it is believed survivors need rescuing. During this situation, an unauthorized access to the artificial intelligence platform can occur, such that an unauthorized party attempts to view the augmented reality 140. The analysis component 310 can continuously monitor the artificial intelligence platform to identify out of the ordinary behavior. With this, the analysis component 310 can identify data that indicates the unauthorized access. The determination component 320 can interpret this data to determine that the unauthorized access occurred and therefore the artificial intelligence platform experienced a breach. The notification component 330 can sent out an alert (e.g., to a network administrator) detailing the breach. The notification can simply be an alert since there may be a low likelihood in this scenario of the unauthorized access being malicious and the benefit of having the augmented reality being fairly high. In a different scenarios, such as a combat scenario, the notification can be to shut down the augmentation.

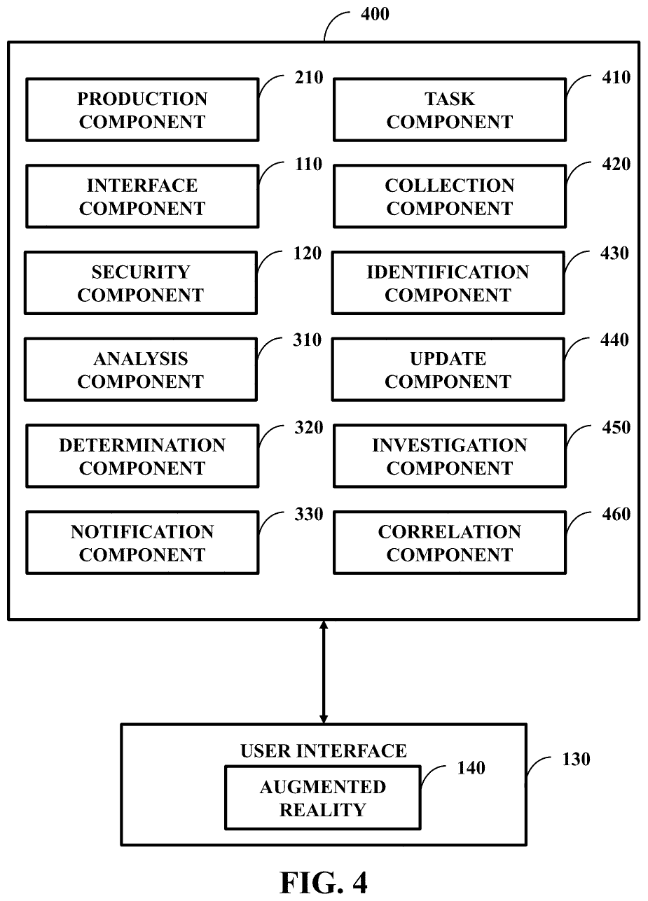

FIG. 4 illustrates one embodiment of a system 400 comprising the production component 210, the interface component 110, the security component 120, the analysis component 310, the determination component 320, the notification component 330, a task component 410, a collection component 420, an identification component 430, an update component 440, an investigation component 450, and a correlation component 460. The task component 410 can be configured to identify a task associated with the augmented reality 140. The production component 210 can produce the augmented reality 140 in a customized manner in accordance with the task.

The collection component 420 can be configured to collect an environmental data set about an environment of the real-world imagery. The identification component 430 can be configured to identify a subset of the environmental data set that pertains to the task, with the subset being less than or equal to the environmental data set. The production component 210 can employs the subset in the production of the augmented reality 140.

Returning to the race example from above, the goal of the competitors can be to travel from “Point A” to “Point B” as quickly as possible with the augmented reality 140 helping a competitor. The task component 410 can determine that the competitor is attempting to travel from “Point A” to “Point B.” The augmented reality 140 could include virtually limitless information—wind speed, temperature, elevation, terrain, precipitation, anticipated movement of others, etc. However, such an augmented reality 140 could be rendered relatively useless if too much information is provided. Therefore, the task component 410, such as with the collection component 420 and the identification component 430, can give a useful augmented reality.

With the race example, the task component 410 can identify the goal of the competitor to travel to “Point B” as quickly as possible. The task component 410 can send an instruction to the collection component 420 to collect information that pertains to the goal and/or ignore information that does not. The identification component 430 can identify information collected that pertains to this goal and forward the identified information to the production component 210. In one example, the identification component 430 can score different information pieces—pieces that meet a threshold can be sent to the production component 210 while pieces that do not meet the threshold can be discarded.

So for the race example, the competitor can start from “Point A” towards “Point B” and cover 25% of the distance. The task can be to reach “Point B” and the collection component 420 can collect information about what surrounds the competitor. The identification component 430 can identify information that pertains to what is in front of the competitor as related to the task with information that pertains to what is behind the competitor as unrelated. This can be since there can be a relatively small likelihood the competitor will reverse course. The production component 210 can use the information about what is in front of the competitor to produce the augmented reality 140.

Further limiting can occur. In one example, artificial intelligence can be employed to determine what information is going to be most useful to the competitor. As an example, humidity can be considered of relatively less value since little can be done to change that, while traffic levels can be considered of relatively more value since that can influence a route taken.

In one embodiment, the augmented reality 140 can be fully or near fully realized; the augmented reality 140 includes all information or nearly all information. The user interface 130 can function to decide what information is presented to the competitor. What information is presented can be based on competitor selection, artificial intelligence inference, behavioral learning, etc.

Additionally, information can change, such as the traffic level going from light to moderate. The update component 440 can be configured to identify an update in the subset of the environment data set. The production component 210 can modify the augmented reality 140 in accordance with the update. Therefore, the production component 210 can produce the augmented reality 140 by creating the augmented reality 140 and/or managing the augmented reality 140, such as updating an existing augmented reality 140.

The security component 120 can perform a verification of the update. Examples of this can include determining that the update is from a trusted source, checking that the updates was properly communicated and not interfered with during transit, and performing a security key check. The production component 210 can modify the augmented reality 140 when verification is successful. As an example, the “Traffic Level” in FIG. 1B can be changed from “Light” to “Moderate” if the update component 440 receives such an update and the security component 120 verifies the update.

The security component 120 can identify the security breach. The investigation component 450 can be configured to investigate a cause of the security breach. This can be why the breach happened or what part of the system 400 and/or supporting hardware/software has a failure or weakness. In one embodiment, the investigation component 450 is configured to perform a self-diagnostic routine. When the cause is determined, the notification component 330 can indicate this cause to an appropriate party (e.g., security personnel).

The system 400 can be configured to handle complex information and data. With this, the correlation component 460 can be configured to correlate a first input from a first source against a second input from a second source to produce a correlation result. The security component 120 can employ the correlation result to limit the access to the user interface. In one example, the first input can be from a user requesting to use the user interface 130. A check can be performed on what party asked for the augmented reality 140 to be created. If this party is not the same as the user, then this can be a mismatch indicating a security breach (e.g., mere requesting by an unauthorized party can be considered a breach).

The security component 120 can function to give quick alert to a user or other entity about a security attack when such an attack does occur. So not only does the security component 120 function to prevent attacks, it can also function to give prompt notification when an attack occurs (e.g., a successful attack). When an attach occurs, the correlation component 460 can gather and correlate information from different sources, with the determination component 320 determining that an attack is occurring through employment of the correlation result. With this, an attack can be identified in real-time (e.g., actual real-time or near real-time) and the notification component 330 can be configured to provide a real-time notification to the user about the security breach by way of the user interface 130 with the security component 120 being configured to identify the security breach to the augmented reality 140 presented on the user interface 130.

The moment an attack happens, information about the attack can be brought forward on the user interface 130 through the augmented reality 140. This can be done without user prompting and the correlation component 460 can determine highly relevant information for the user so as to not cause information overload. The highly relevant information can be presented to the user in a three-dimensional form integrated into the augmented reality 140. Based on this augmented reality 140, the user can make a final decision (e.g., to stop using the augmented reality 140) or an artificial intelligence component can make the final decision (e.g., stop use for all users, stop use for users of one classification (e.g., enlisted) and allow use for another classification (e.g., officers)). The correlation component 460 can be configured to correlate a first input from a first source that pertains to the security breach (e.g., a server) against a second input from a second source that pertains to the security breach (e.g., a client) to produce a correlation result. The determination component 320 can be configured to make a determination that the first input should be integrated into the augmented reality 140 and that the second input should not be integrated into the augmented reality 140, the determination is based, at least in part, on the correlation result. Based on this, the real-time notification can incorporate the first input and does not incorporate the second input.

The determining of a security breach and the decision on what to tell a user about the breach so the user does not experience information overload can work together. In one example, in response to the determination component determining that the artificial intelligence platform experienced a security breach, the correlation component 460 can be configured to correlate a first input from a first source that pertains to the security breach against a second input from a second source that pertains to the security breach to produce a correlation result. The analysis component 310 can be configured to make a decision that the first input should be included in the notification and that the second input should not be integrated into the notification, with the decision being based, at least in part, on the correlation result. The notification component 330 can provide the notification with the first input and without the second input.

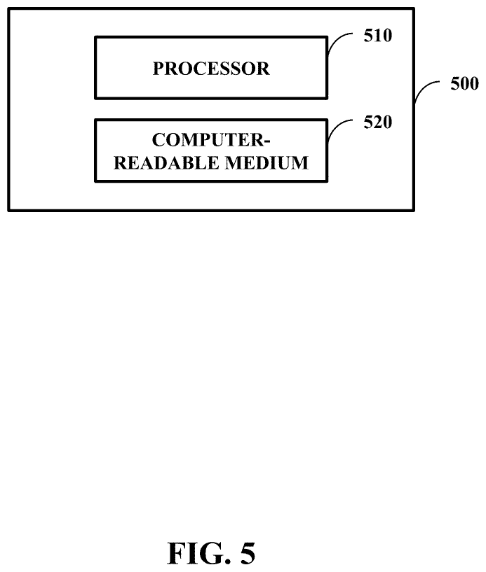

FIG. 5 illustrates one embodiment of a system 500 comprising a processor 510 and a computer-readable medium 520 (e.g., non-transitory computer-readable medium). In one embodiment, the computer-readable medium 520 is communicatively coupled to the processor 510 and stores a command set executable by the processor 510 to facilitate operation of at least one component disclosed herein (e.g., the interface component 110 or the network analysis component discussed below). In one embodiment, at least one component disclosed herein (e.g., the production component 210) can be implemented, at least in part, by way of non-software, such as implemented as hardware by way of the system 500. In one embodiment, the computer-readable medium 520 is configured to store processor-executable instructions that when executed by the processor 510, cause the processor 510 to perform at least part of a method disclosed herein (e.g., at least part of one of the methods 600-900 discussed below).

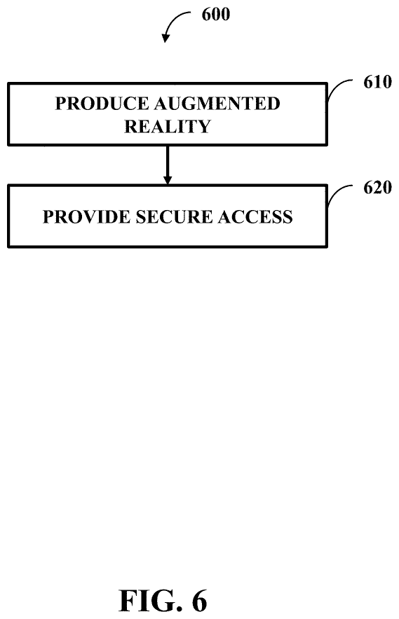

FIG. 6 illustrates one embodiment of a method 600 comprising two actions 610-620. At 610, the augmented reality 140 of FIG. 1 can be produced. At 620, secure access to the augmented reality 140 of FIG. 1 can be provided, such as by way of the user interface 130 of FIG. 1.

Security can be embedded at the user interface 130 of FIG. 1. This embedded security can prevent another party from seeing what a user sees upon the user interface 130 of FIG. 1. In addition to prevention, when a security breach occurs (e.g., at the user interface 130 of FIG. 1), the user interface 130 of FIG. 1 can notify the user that someone else is viewing what they view. The user interface 130 of FIG. 1 can be interactive (e.g., augmented data is presented upon request), so the user can be mindful if the user knows someone else is watching.

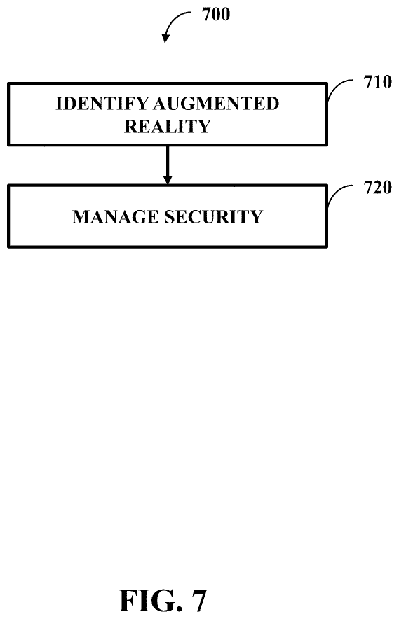

FIG. 7 illustrates one embodiment of a method 700 comprising two actions 710-720. The augmented reality can be produced at 710. Secure access can be provided to the augmented reality can occur at 620. This secure access can work to stop the augmented reality 140 of FIG. 1 from being accessed as well as the production component 210 of FIG. 2 from being modified from an unauthorized party (e.g., creation logic employed by the production component 210 of FIG. 2 in creating/managing the augmented reality 140 of FIG. 1 is modified by an enemy).

This security can be embedded in an artificial intelligence component that is part of the artificial intelligence platform such that when a modification occurs, it can be detected as well as thwarted or it can be identified why the modification was able to occur. The artificial intelligence component can employ artificial intelligent learning to improve itself so when a modification occurs, the security component 120 of FIG. 1 can learn why and not allow it to happen again. With this, the artificial intelligence platform can be a machine learning platform.

In one embodiment, the artificial intelligence platform can be a deep learning platform. An example deep learning platform implemented as the artificial intelligence platform can be a five layer learning platform. Example layers can include an artificial intelligence-enabled cybersecurity platform, an artificial intelligence-enabled secured application platform, a secured natural language processing platform, a secured expert system platform, a secured speech platform, a secured robotics platform, secured operating systems/virtual machines, a secured transport protocol, a secured/Internet/routing protocol, a secured media access protocol, and a secured physical layer protocol.

A secure artificial intelligence-based secured augmented reality-enhanced platform can be configured in individual layer of application architecture to reduce security information overloads for the user. The secured augmented reality interface (e.g., the user interface 130 of FIG. 1) can be employed as the final user interface for the individual layer of application architecture while artificial intelligence is being a core common infrastructure including the augmented reality 140 of FIG. 1 and cybersecurity (e.g., achieved by the security component 120 of FIG. 1). Artificial intelligence-enabled cybersecurity application of an individual layer can configured with an artificial intelligence-enabled-augmented reality platform for reducing information overloads. The three-dimensional representations of real-world information augmented with annotated virtual-world objects for decision making, correlating a vast amount of inputs from multiple sources make it easy for users to make decisions in real-time. The artificial intelligence-enabled secured augmented reality user interface (e.g., the user interface 130 of FIG. 1) can foster interoperability and scalability using augmented reality and artificial intelligence as a common technology for cybersecurity application and other network applications.

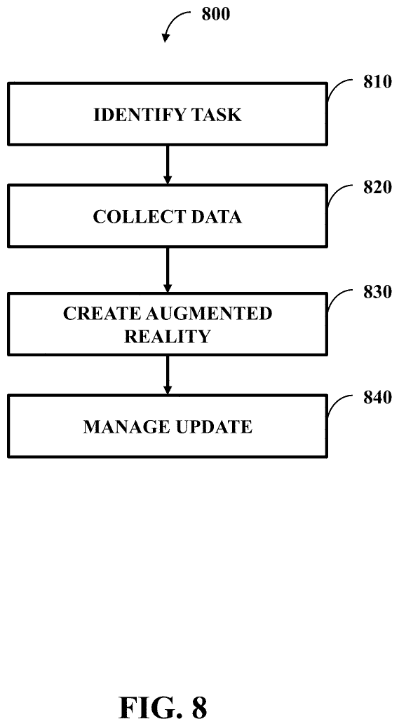

FIG. 8 illustrates one embodiment of a method 800 comprising four actions 810-840. At 810, a task can be identified. As discussed above, the task can be for a user of the user interface 130 of FIG. 1 to travel from “Point A” to “Point B.” Data that pertains to the task can be collected at 820, such as data about terrain within a specified distance between “Point A” and “Point B.” As an example, a straight line between “Point A” and “Point B” can be identified and information about terrain 1 mile in various directions from that straight line can be gathered.

At 830, the augmented reality 140 of FIG. 1 can be created, such as through use of the terrain information discussed above. Once the augmented reality 140 of FIG. 1, updates to the terrain information can be propagated to the augmented reality 140 of FIG. 1. As one example, when created, an area of terrain can be covered in an inch of snow; later the area can be covered in two inches of snow. The augmented reality 140 of FIG. 1 can be updated so that it formerly illustrates one inch of snow, but later illustrates two inches of snow.

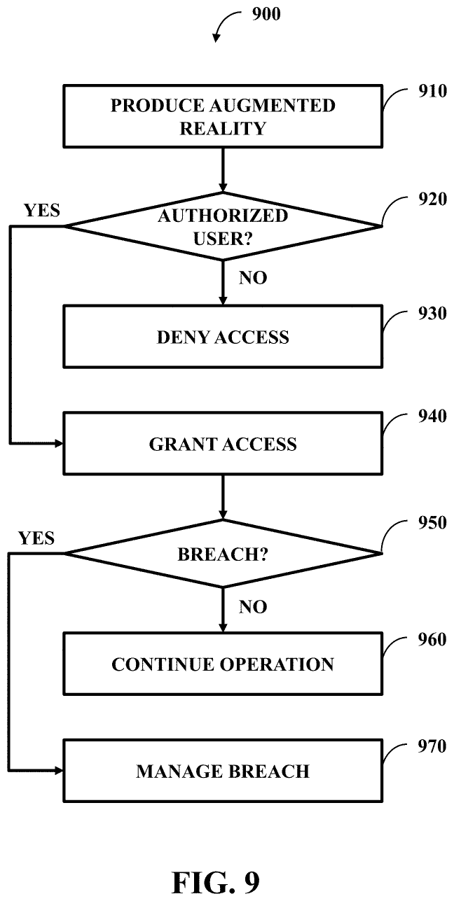

FIG. 9 illustrates one embodiment of a method 900 comprising seven actions 910-970. At 910, the augmented reality 140 of FIG. 1 can be produced (e.g., in accordance with the method 800 of FIG. 8). A user, by way of a user interface, can request access to the augmented reality 140 of FIG. 1. At 920, a check can determine if the user should be granted access. If not, then at 930 access can be denied and if so, then at 940 access can be grated.

A check can occur at 950 on if a security breach occurs. If no breach occurs, then normal operation can take place and/or continue at 960 (e.g., a normal user experience continues, but back end changes are made in view of an attempted breach). If a breach occurs, then at 970 the breach can be managed (e.g., the augmented reality 140 of FIG. 1 can be shut down).

While the methods disclosed herein are shown and described as a series of blocks, it is to be appreciated by one of ordinary skill in the art that the methods are not restricted by the order of the blocks, as some blocks can take place in different orders.

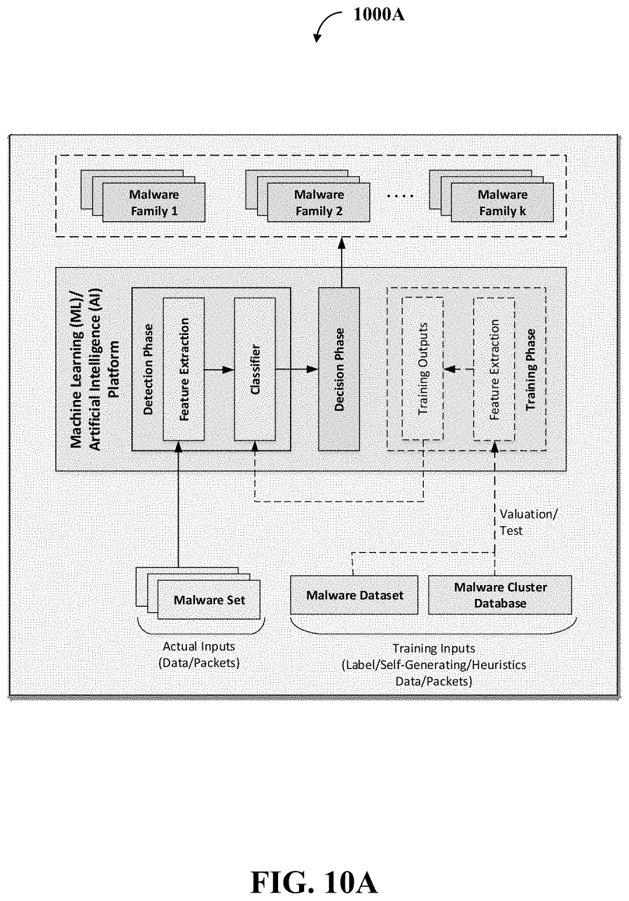

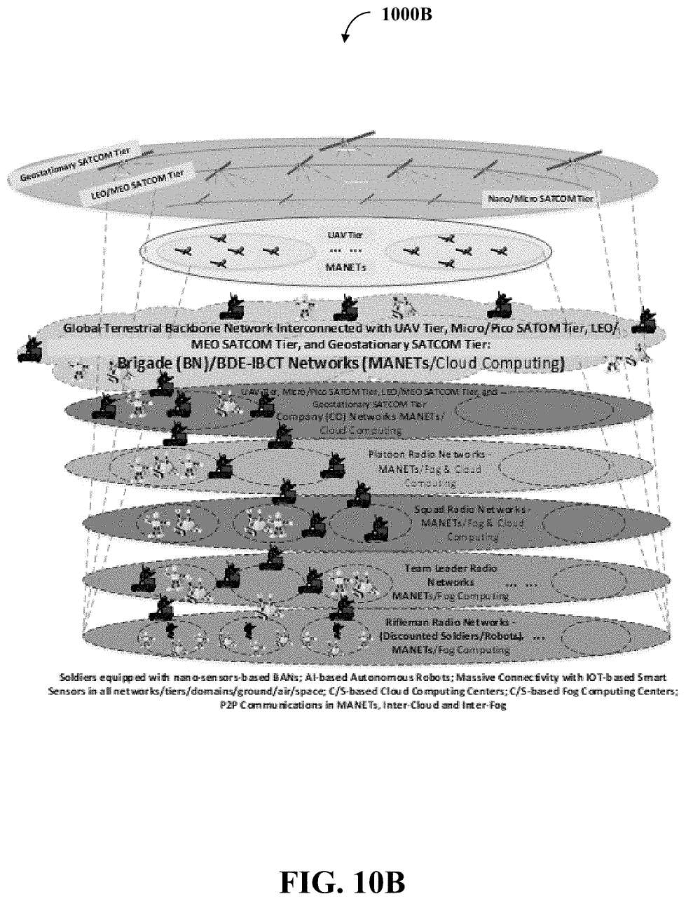

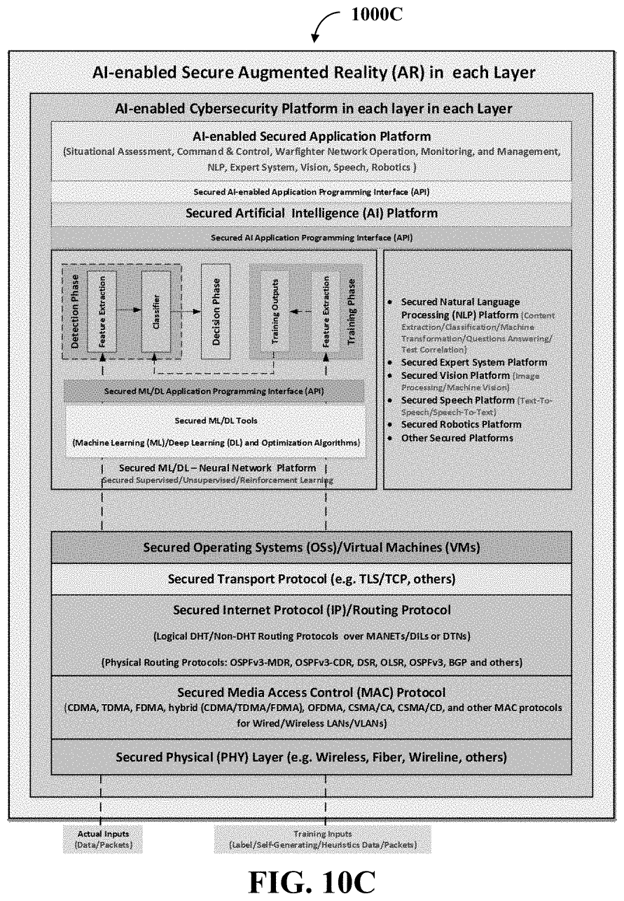

FIG. 10A illustrates one embodiment of a detection platform 1000A, FIG. 10B illustrates one embodiment of a network architecture 1000B, and FIG. 10C illustrates one embodiment of an applications architecture 1000C. The detection platform can be employed with a secure artificial intelligence (AI)-based augmented reality (AR)-enhanced warfighter application architecture. The architecture can uses secure AR (e.g., the augmented reality 140 of FIG. 1) as part of the user interface for in individual application while AI is a core common infrastructure including AR and cybersecurity. Cybersecurity can employ AR for reducing information overloads. The three-dimensional (3D) representations of real-world information augmented with annotated virtual-world objects for decision making, correlating a vast amount of inputs from multiple sources can make it easy for warfighters to make decisions in real-time. This architecture can foster interoperability and scalability using AR and AI as the common technology for cybersecurity and other applications. Although this architecture is discussed with warfighter applications, it can be employed in other areas (e.g., commercial applications, such as the race example discussed above as well as health-care, retail, education, and industrial design).

Real-time interactive (AR) applications that use 3D virtual objects integrated into the real environment in real time can be implemented with cybersecurity aspects (e.g., implemented through the security component 120 of FIG. 1). The 3D interactive AR applications can reduce users' cognitive loads and restore perspective and comprehension of overwhelming amounts of network security data in an improved manner to what complicated 2D display or visualization cannot provide. Furthermore, tools that combine augmented reality with a deep learning neural network, an aspect of artificial intelligence (AI) can be employed by the production component 210 of FIG. 2. Example user interfaces 130 of FIG. 1 that can illustrates the augmented reality 140 of FIG. 1 produced by the production component 210 of FIG. 2 can include AR-enhanced automotive windshields and powerful head-mounted displays (HMDs), and smartphones.

Cybersecurity analysis becomes more complicated for warfighter networks that comprise manned and unmanned ground mobile ad hoc networks (MANETs), mobile cellular networks, unmanned aerial vehicle (UAV) networks, mobile and geostationary satellite networks, and terrestrial networks spanning across the globe. It can be complex how security virtualizations enriching with real world perceptions promise to instantly communicate cyber threats, patterns, and attacks in real-time to warfighter network analysts, enabling them to combat cyber-attacks immediately, when AR integrated with AI is used. To manage this complexity, a framework for Secure Artificial Intelligence-based Augmented Reality for Cyber Security of Warfighter Networks can be employed.

Numerous devices that are connected over the networks, especially across global warfighter networks, can be AR-enabled because of the enormous benefit to reduce information overloads for easy understanding of vast amounts of information with 3D precise representation. AR is an extremely useful tool for decision making because it integrates both real-world and virtual-world objects. However, AR system can be very vulnerable to cyberattacks, such as with changed or obstructed information. Adversaries could intentionally manipulate real-world or virtual-world objects showing important high-value targets from a warfighter's view, or produce output to distract the warfighter's view. Sensory overload, caused by flashing visuals, shrill audio, or intense haptic feedback signals, could cause physiological damage to the warfighter. The networked AR devices deployed in worldwide warfighter networks can amplify the possible threats for contents shared among all entities across the network.

It can be challenging to understand every possible AR content, their application behavior, and target environments. Another challenge can be how to deploy diverse changeable security policies, patches, authentication, authorization and other features using manual or non-automatic ways. For example, consider a desire to move virtual objects to less obstructive positions in the environment for AR devices across the network, meeting security objectives in a non-intrusive way. It can be difficult to comprehend how one might move the objects such that they simultaneously do not interfere with each other and do not obstruct real-world objects, which themselves may be moving (e.g. vehicles or other objects).

The cybersecurity for AR system can be devised using AI technologies for generation of security policies, patches, authentication, authorization and other features dynamically in real-time using centralized or distributive security architecture. Like AI-based AR, the AI-based cybersecurity system for AR can use, as examples, machine learning, neural network, and machine vision. Different algorithms can be used to meet different objectives.

AR offers various modes of visualization, navigation, and use interaction combining both real-worlds and virtual-worlds in more authentic and reliable ways. A benefit of AR perception and interactions is to identify and understand real-world scenarios and objects, and add virtual objects to these scenarios in a more direct and institutive way reducing the information overloads of users in understanding the hugely complex information scenarios generated from multiple sources simultaneously in real-time.

Deep-learning and machine vision-based object detection and environment understanding can be combined with host devices' built-in global positioning system (GPS) receivers, inertial measurement unit and magnetometer in AR. In addition, virtual objects and GPS location coordinates of geographic objects generated from the geospatial information database can be precisely integrated with the real-world by the production component 210 of FIG. 2 along with the development of the interaction method based on touch gestures supplied to the user interface 130 of FIG. 1.

Marker-less deep learning and simultaneous localization and mapping (SLAM) technologies can be used in AR, while a convolutional neural network (CNN) can be used to identify and segment objects and scenarios in a single-frame image or multi-frame video. This process of the machine learning and computer vision of artificial intelligence (AI) technology can include classification, detection, and semantic and object segmentation. The process identifies the type, position, and boundaries of an object, and further segments the underlying components of the same type of objects. For geometrical understanding of objects, the production component 210 of FIG. 2 can use SLAM for inside-out tracking and positioning for achieving both simultaneous localization and mapping. The mapping process in SLAM can be used for 3D reconstruction, providing an ideal interface of presenting virtual information.

Aspects that pertain to AR can be internet-of-things (IoT) devices, networked sensors, live streaming videos and their players, and other devices that are generating enormous amount of time-series traffic across the network. The amount of security information from different sources of different network entities that can be correlated in real-time can be processed by the correlation component 460 of FIG. 4. The AR can function with a 2-D display as the user interface 130 of FIG. 1, but this can become convoluted, compromising users' cyber-threat perspective due to network size and complexity. A 3D display as the user interface 130 of FIG. 1 of data with cyber-physical context, as the augmented reality 140 of FIG. 1, generated by the production component 210 of FIG. 2 can create a naturally intuitive interface that helps restore perspective and comprehension sacrificed by complicated 2D visualizations.

Cyberattacks using malware can be virtualized transforming from the cyber-virtual application software programming raw data-space to physical-space proving a concrete situational awareness for unlocking their true meaning. Security visualizations can instantly communicate anomalous patterns to network analysts, enabling them to make swift and informed assumptions to combat cyberattacks. For example, if cyberattacks cause buffer overflow disrupting a server, terminal, or device, a network analysis component can learn the actual address of a given software program-codes where malware-codes have been injected, the specific application to which this malware-injected software belongs to (e.g., out of many applications that may reside from the physical layer to the upper application layer), transport layer port address, network layer address, link/medium access layer address, physical layer address, physical connectivity address within the network topology, global cyber network topology, mapping of the cyber network topology to the physical topology that may consisting of geographical map, building address, floor number, room number, cubical number, and actual location of the physical entity within a cubical, and other information. Moreover, data can be fed from multiple sources in diagnosing the malware. In analyzing the malware, example processes that can be employed by the security component 120 of FIG. 1 can include disassembling and unpacking of malware, feature extractions like instruction encoding, n-gram analysis, and creation of feature vectors, comparison of the malware with the exiting known malware forming clusters and the particular family of malware that the attack-malware codes belong to, and others.

This cyberattack example shows that a huge amount of information can be analyzed, correlated, and digested by the network analysis component causing information overloads. Information saturation not only threatens comprehension, but may also produce apathy. The danger is that the user may ignore threats when buried in extraneous visual information subconsciously, or consciously. With this, the AR can facilitate visualizing data in an appropriate cyber-physical context to imbue data with meaning normally inaccessible in two dimensions.

For cybersecurity virtualization, the virtual objects can be created from with training inputs that are known malware datasets, malware similarity/locality sensitive hashing (LSH) clusters, and other information and are stored appropriately, thereby, forming the virtual-world malware database. The actual inputs can be real-world malware datasets feeding from multiple sources in real-time. The ML-AI algorithms can be very specific to malware detection for creating malware-specific virtual objects. These malware-specific virtual objects can then be used for registration. These registered virtual objects can be combined with real-world malware information with 3D video along with gesture by touching frame for malware virtualization and interaction.

There can be a goal to not only build cyber-defenses both in software/hardware, but make their computing processes proactive (e.g., automatic) by even removing the human-in-the-loop in the analysis process. Smart richer human-machine interfaces can function to interpret the results to human users and this can be done by the security component 120 of FIG. 1.

Artificial intelligence algorithms employed by the security component 120 of FIG. 1 can including machine learning and natural language processing (NLP) can prevent, detect, and repair the cyber-systems against newer unknown sophisticated cyber-attacks (e.g. polymorphic malware and persistent threats) using an automated process even without human interventions. An approach for ML/AI-based malware detection can be practiced, in one example, in accordance with the detection platform 1000A.

A set of malicious or suspicious software program samples termed as malware can be taken as the actual inputs. The feature extraction stage can include disassembling and unpacking of the packed malware set. In the instruction encoding stage, individual instructions can be converted with a sequence of encoded operation codes that capture the underlying semantics of the programs. An n-gram analysis can characterize the content of a malware program through moving a fixed-length window over the sequence and of length n at different positions. The resulting n-gram of opcodes reflects short instruction patterns and implicitly captures the underlying program semantics. In the classifier phase, hashing can be used for compressing the feature vectors, significantly improving the speed of similarity computation while incurring only a small penalty in clustering accuracy. The clustering algorithm can be applied on the set of compressed feature vectors and partitions samples into different clusters, each representing a group of similar malicious programs, and can be compared with the existing malware families determining the malware family to which they belong to or identifying the similarity to an existing malware family identified during the training phase in case of the new malware. While the platform 1000A provides a high-level description, one of ordinary skill in the art can appreciate more that implementation can feature more detailed complexities that are involved in training, feature extraction, and detection of malware.

The network architecture 1000B illustrates one example of diverse applications with the span of space tier, airborne tier, unmanned airborne vehicle (UAV) tier, and ground (manned and unmanned) tier along with mobile ad hoc networks (MANETs), mobile cellular wireless networks, and fixed wireline networks. The architecture 1000B can be considered a high-level view of the multi-domain warfighter network architecture.

Military operations can, like the network architectures, be diverse in their nature. Applications like situational awareness (SA), command & control, battlefield assessment, quick reaction forces, mounted/dismounted operations, training, embedded training, forward observer training, live warfare simulation, and many others that deal with one complete picture of the past history, current status, and potential consequences of actions in the warfare environment. These operations can supply a vast amount of information, possibly leading to information overflow. The condition of information overload occurs when one is unable to process the information presented into coherent SA. With the rapidly expanding ability to collect data in real-time/near real-time about many locations and providing data abstractions to the warfighter at levels from the command center to individual field personnel, the danger of information overload has grown significantly.

A commander may benefit from understanding the global situation, and how the various teams are expected to move through an environment, whereas a private on patrol may only be concerned with a very limited area of the environment. Similarly, a medic may need health records and a route to an injured soldier, whereas a forward observer may need a few days' worth of reconnaissance information in order to detect unusual or unexpected enemy actions. The task component 410 of FIG. 4 can be aware of these various tasks, the mission plans (e.g., including contingencies), and the current roles that a particular user may fulfil at a given time.

It should also be evident at this point that an AR system for military applications bridges two somewhat disparate fields. SA compels that the visual representations of data be introduced. Overlaying information can be a fundamental characteristic of AR, and this sensory integration can both limit the types of abstractions that make sense for a given application and push the application designer to create new methods of understanding perceptual or cognitive cues that go beyond typical human sensory experiences.

Military applications described earlier can function with huge amounts of information processing in real-time. With an SA example application, many sub-applications can be employed to build this complex application. Thousands/millions of sensors with time series traffic in real-time, real-time audio-video conferencing, application sharing, live streaming of videos from the battlefield, information about network entities across the multi-domain network, location coordinates of mobile and fixed entities fed by GPS in real-time, and others can be examples of sub-application. In view of this, artificial intelligence can be used to process this information for fusion of information that provides the final actionable intelligence to the commanders' disposal in real-time.

In view of this, military applications and other complex applications can be AI-enabled. The process for an AI-based application can be structured as in, or similar to, the platform 1000A. The AWL algorithms can, when appropriate, be different. For example, an example SA application can employ specific algorithms related to the specific features of individual sub-applications.

The artificial intelligence/machine learning itself can also be subject to cyberattacks as attackers are also able to attack the training inputs or real-world input datasets in a way that can poison the training or actual inputs using an AWL system; the security component 120 of FIG. 1 can also protect the AI/ML itself. One manner can be to use more hidden layers in the neural networks for the deep machine learning neural network system.

To achieve security, a secure architectural framework for artificial intelligence-based warfighter applications enhanced with augmented reality can be employed. The situation for warfighters is important because the enormous amount of information should be processed and taken care of before making final decision in split-second time duration in real-time. A military application can be AR-enhanced including cybersecurity, as if, AR is acting as the final application for user interface 130 of FIG. 1. Military applications can be mission critical and achieve faster response times of the order of few milliseconds to seconds. So, AR-enhanced military applications demand that AR should be fast, and this can be achieved by being AI-enabled. However, AR itself should be secured as discussed above.

Security applications can function with AR reality correlating inputs (e.g., by the correlation component 460 of FIG. 4) from different sources making sense what is the actionable awareness for decision making in real-time augmenting the real-world scenarios with the virtual-world objects for easy to understand reducing information overloads to warfighters. On the other hand, military applications themselves can be AI-enabled because of the complexities of those applications for faster fusion of all information. In other words, AI can be the core infrastructure for military applications as well. The architecture 1000C can function as an example logical view of a secure AI-based AR-enhanced applications architecture.

Cybersecurity can be employed at different steps for individual logical entity of different applications no matter where they are or where they belong to including the AR. As mentioned earlier, the secured AR platform can act, as if, as the user interface 130 of FIG. 1 for warfighter users or commercial users.

With respect to AI platform, ML can be used for cybersecurity and other applications. However, NLP, expert system, vision platform, speech and robotics systems can also be integrated fully for getting the ultimate benefit of making them behave like AI. Similarly, the common standards for different algorithms specific to each application (e.g. AR, cybersecurity, applications [e.g. SA, Command & Control, Network Management]) can be created fostering interoperability further to the application infrastructure. The architecture 1000C and similar architectures can create interoperability for the basic core software and hardware infrastructure removing duplication of the same thing as well as economies-of-scale for developing cheaper AI/ML-enabled AR, cybersecurity, and other application products.

Secure augmented reality can be beneficial for warfighter applications for reducing the information overloads. Moreover, the cybersecurity application itself also can benefit from being AR-enabled. This is because AR can sum real-world information received from multiple sources in real-time and point to essential information for decision making at once with annotation of virtual objects in 3D form to warfighters.

What is claimed is:

1. An artificial intelligence-based augmented reality system, comprising:
an interface component configured to cause display of a user interface; and
a security component, embedded in an artificial intelligence platform, configured to limit access to the user interface,
where the user interface displays an augmented reality that combines real-world imagery with augmented imagery and
where the augmented reality is produced through employment of the artificial intelligence platform.

2. The system of claim 1, comprising:
a production component configured to produce the augmented reality through employment of the artificial intelligence platform.
where the augmented reality is a three-dimensional augmented reality.

3. The system of claim 2, comprising:
a task component configured to identify a task associated with the augmented reality;
where the production component produces the augmented reality in a customized manner in accordance with the task.

4. The system of claim 3, comprising:
a collection component configured to collect an environmental data set about an environment of the real-world imagery,
an identification component configured to identify a subset of the environmental data set that pertains to the task,
where the production component employs the subset in the production of the augmented reality.

5. The system of claim 4, comprising:
an update component configured to identify an update in the subset of the environment data set,
where the production component modifies the augmented reality in accordance with the update and
where the subset is less than the environment data set.

6. The system of claim 5, comprising:
where the security component performs a verification of the update and
where the production component modifies the augmented reality when the verification is successful.

7. The system of claim 2, comprising:
a correlation component configured to correlate a first input from a first source against a second input from a second source to produce a correlation result,
where the security component employs the correlation result to limit the access to the user interface.

8. The system of claim 1, comprising:
an analysis component configured to analyze the artificial intelligence platform to produce an analysis result;
a determination component configured to make a determination if the artificial intelligence platform has experienced a security breach based, at least in part, on the analysis result; and
a notification component configured to provide a notification through the user interface that indicates existence of the security breach when the determination is that the artificial intelligence platform has experienced a breach.

9. The system of claim 8, comprising:
an investigation component configured to investigate a cause of the security breach,
where the notification indicates the cause of the security breach.

10. The system of claim 8, comprising:
a correlation component configured to correlate a first input from a first source that pertains to the security breach against a second input from a second source that pertains to the security breach to produce a correlation result; and
an analysis component configured to make a decision that the first input should be included in the notification and that the second input should not be integrated into the notification, the decision is based, at least in part, on the correlation result,
where the notification component provides the notification with the first input and without the second input.

11. The system of claim 1,
where the artificial intelligence platform is a deep learning platform comprising at least five layers.

12. The system of claim 1,
where the artificial intelligence platform is a machine learning platform.

13. A system, comprising:
a production component configured to produce an augmented reality through employment of an artificial intelligence platform; and
a security component, embedded in the artificial intelligence platform, configured to limit access to the production component to an allowable party set,
where the augmented reality is accessible by way of a user interface.

14. The system of claim 13, comprising:
a task component configured to identify a task associated with the augmented reality;
where the production component produces the augmented reality in a customized manner in accordance with the task.

15. The system of claim 14, comprising:
a collection component configured to collect an environmental data set,
an identification component configured to identify a subset of the environmental data set that pertains to the task,
where the production component employs the subset in the production of the augmented reality.

16. The system of claim 15, comprising:
an update component configured to identify an update in the subset of the environment data set,
where the production component modifies the augmented reality in accordance with the update.

17. The system of claim 16, comprising:
where the security component performs a verification of the update and
where the production component modifies the augmented reality when the verification is successful and
where the subset is less than the environment data set.

18. The system of claim 13, comprising:
a correlation component configured to correlate a first input from a first source against a second input from a second source to produce a correlation result,
where the security component employs the correlation result to limit the access to the augmented reality.

19. An artificial intelligence-based augmented reality system, which is at least partially hardware, the system comprising:
a security component, embedded in an artificial intelligence platform, configured to identify a security breach to an augmented reality presented on a user interface; and
a notification component configured to provide a real-time notification to the user about the security breach by way of the user interface,
where the augmented reality is a three-dimensional augmented reality.

20. The system of claim 19, comprising:
a correlation component configured to correlate a first input from a first source that pertains to the security breach against a second input from a second source that pertains to the security breach to produce a correlation result; and
a determination component configured to make a determination that the first input should be integrated into the augmented reality and that the second input should not be integrated into the augmented reality, the determination is based, at least in part, on the correlation result,
where the real-time notification incorporates the first input and does not incorporate the second input.
